(19) United States
(12) Patent Application Publication
(10) Pub. No.: US 2002/0177643 A1
(43) Pub. Date: Nov. 28, 2002

(54) Flame-retardant polycarbonate molding compounds with anti-electrostatic properties

(76) Inventors: Martin Dobler, Dusseldorf (DE); Walter Kohler, Duisburg (DE); Michael Erkelenz, Duisburg (DE); Andreas Seidel, Dormagen (DE); Hugo Obermann, Dormagen (DE)

Correspondence Address: BAYER CORPORATION, PATENT DEPARTMENT, 100 BAYER ROAD, PITTSBURGH, PA, 15205, US

(21) Appl. No.: 10/121,572

(22) Filed: Apr. 12, 2002

(30) Foreign Application Priority Data
Apr. 17, 2001 (DE) 10118787.4

(51) Int. Cl. C08K 5/36

(52) U.S. Cl. 524/392

(57) ABSTRACT

A flame-retardant composition having anti-electrostatic properties is disclosed. The composition contains (co)polycarbonate, a flame retardant selected from a specifically defined group and a polyalkylene ether compound.

### FIELD OF THE INVENTION

The present invention relates to thermoplastic molding compositions and more particularly to flame-retardant compositions having anti-electrostatic properties.

### SUMMARY OF THE INVENTION

A flame-retardant composition having anti-electrostatic properties is disclosed. The composition contains (co)polycarbonate, a flame retardant selected from a specifically defined group and a polyalkylene ether compound.

### BACKGROUND OF THE INVENTION

Flame-retardants are used to produce flame-retardant amorphous thermoplastic polymers such as polycarbonates. They are generally known and described, for example, in B. J. Sutker, “Flame Retardants”, Ullmann's Encyclopedia of Industrial Chemistry, 6th Edition, 1998. Polycarbonate molding compounds with a flame-retardant finish are also known, for example, from DE-A 199 07 831, U.S. Pat. Nos. 4,239,678, 4,727,101, 3,940,366, 3,933,734.

Most plastics materials, including the molding compounds described in the above-mentioned patents, are electrical insulators with a high electrical surface resistance. Therefore an electric charge which is easily created in the surface of the plastics material by contact with other materials or by friction during processing is only dissipated extremely slowly and leads to various disturbances and annoyances in practice, in particular to rapid soiling and creation of dust from the plastic parts while forming undesirable characteristic dust patterns. A further problem which frequently occurs is the destruction of sensitive electronic components by electrostatic charges in the immediate environment, for example through the housing.

The plastics' surface resistance and tendency to attract dust may be reduced by addition of so-called antistatic agents. Conventional commercial additives which may be used to provide plastics materials with anti-electrostatic properties include, for example, alkyl and aryl sulphonates, ethoxylated alkyl amines, quaternary ammonium and phosphonium salts and fatty acid esters (cf., for example, A. Lichtblau, “Antistatika”, Kunststoffe 86 (1996) 7, pages 955 to 958 and EP-A2 0 897 950). The use of specific polyalkylene ethers/polyalkylene glycols to impart anti-electrostatic properties to plastics materials is described in the patent literature.

DE-A 1 297 341 discloses, for example, a method of imparting antistatic properties to polymers made up exclusively or predominantly of carbon and hydrogen (in particular polyethylene) by surface treatment with or incorporation of polyalkylene glycols.

FR-B-1 239 902 describes the use of ethylene/propylene oxide three-block copolymers for imparting antistatic properties to polymers. The three-block copolymers should deploy their antistatic action in polymethyl methacrylate, PVC, polyethylene, polystyrene and ABS molding compounds.

DE-A-19 817 993 describes ABS plastics materials provided with antistatic properties by specific three-block copolymers of formula X-Y-X having a central block Y composed of propylene oxide units and terminal blocks X composed of ethylene oxide units. The average proportion of ethylene oxide units in this three-block copolymer is 2 to 35 wt. %.

The use of polypropylene glycol as an antistatic agent for ABS resins is described in DE-A-1 244 398. To achieve a significant effect, however, polypropylene glycol has to be used in large quantities (typically, for example, 5 wt. %) and this can lead to finished articles with patchy greasy surfaces and even to surface coatings on the finished plastic articles and/or in the injection molding tool.

PC/ABS molding compounds containing polyalkylene ethers/polyalkylene glycols are also known.

EP-A2-0 278 348 describes PC/ABS molding compounds having antistatic properties obtained using specific polyalkylene ethers. The polyalkylene ethers used have been modified by treatment with radical-forming substances to increase their efficiency as an antistatic agent.

Although the polycarbonate molding compounds with polyalkylene ethers or other antistatic agents such as sulphonates, described in the aforementioned patents/patent applications are distinguished by anti-electrostatic behaviour, they are not flame-retardant but, on the contrary, much more highly flammable than pure polycarbonate. For many applications, however, flame retardance is absolutely essential and antistatic behaviour also desired. However, it has proven extremely difficult to obtain polycarbonate molding compounds with both anti-electrostatic and flame-retardant properties because the antistatic agents which can be used are generally highly flammable so their addition to the molding compound makes it more difficult to obtain flame-retardant properties therein.

JP-A2-02202544, on the other hand, describes polycarbonate molding compounds which exhibit better flame retardance to UL 94 (Test for Flammability of Plastic Materials for Parts in Devices and Appliances, Underwriters Laboratories, Northbrook, Ill., USA) owing to a combination of 0.1% potassium diphenyl sulphonate and 0.3% polyethylene glycol oligomer (PEG 600) than the corresponding trial with PEG 3400 or without PEG. However, these molding compounds do not have an anti-electrostatic activity.

It was accordingly an object of the present invention to provide molding compounds with both anti-electrostatic and flame-retardant properties, which have good mechanical and thermal properties and are easy to process by injection molding. For logistical reasons, it is also advantageous to find an additive with which conventional polycarbonate molding compounds having flame-retardant properties can be given anti-electrostatic properties in transparent and opaque formulations and in various colors.

It has now surprisingly been found that polycarbonate compositions containing specific polyalkylene ethers and flame-retardants exhibit synergism with specific antistatic agents with respect to the antistatic activity and therefore meet the necessary requirements.

### DETAILED DESCRIPTION OF THE INVENTION

The present invention accordingly relates to polycarbonate compositions containing:

Non-halogenated aromatic polycarbonate or polyester carbonate, at least one halogenated and/or sulphur-containing flame retardant and at least one polyalkylene ether compound based on propylene oxide and ethylene oxide with a propylene oxide content of ≧75 wt. %, preferably ≧80 wt. %, particularly preferably ≧90%, relative to the weight of polyalkylene ether compound.

The compositions may optionally also contain a fluorinated polyolefin, a finely divided inorganic material, a further polymer component and further conventional polymer additives.

Preferred compositions consist of non-halogenated polycarbonate containing

A) 0.001 to 5 wt. %, preferably 0.01 to 0.5 wt. %, relative to the weight of the composition, of one or more flame-retardants according to (I), (II), and/or 0 to 10 wt. %, preferably 0 to 6 wt. % relative to the weight of the composition, of (IIII),

(I) [R—SO₃⁻]ₙMⁿ⁺ wherein R represents an aromatic or aliphatic group, preferably a straight-chain or branched aliphatic radical containing 1 to 30 carbon atoms or an aromatic radical containing 6 to 30 carbon atoms, which may be completely or partially halogenated, in particular also partially or completely fluorinated, compounds wherein R=linear or branched aliphatic radical containing 1 to 18 carbon atoms and at least one fluorine atom, in particular perfluoroalkylated compounds containing 2 to 12 carbon atoms, n corresponds to the valence of M and M represents any metal, akali and alkaline-earth metals being particularly suitable

(II) (Ar—SO₂—NR—)ₙM⁺ wherein Ar is an aromatic group, R a monovalent aliphatic radical or Ar and R together form a bivalent aromatic radical, M is any cation and n corresponds to the valency of M,

(III) a halogenated oligo or polycarbonate,

B) 0.05 to 10 wt. %, preferably 0.1 to 5 wt. %, in particular 0.5 to 4 wt. % relative to the weight of the composition of a polyalkylene ether compound based on propylene oxide and ethylene oxide with a propylene oxide content of ≧75 wt. %, preferably ≧80 wt. % and particularly preferably ≧90 wt. % relative to the weight of polyalkylene ether compound, and with a number average molecular weight of ≧2,000 g mol⁻¹, preferably ≧3,000 g mol⁻¹, in particular ≧3,500 g mol⁻¹,

and optionally

C) 0 to 5 wt. %, preferably 0 to 1 wt. % relative to the weight of the composition, in particular 0 to 0.3 wt. % of a fluorinated polyolefin,

D) 0 to 10 wt. %, preferably 0 to 3 wt. % relative to the weight of the composition, in particular 0 to 1 wt. % of at least one further conventional polymer additive.

For use as a masterbatch, the compositions according to the invention contain 0.01 to 50 wt. %, preferably 1 to 20 wt. %, relative to the weight of the masterbatch, of one or more flame-retardants according to (I), (II), and/or 0 to 90 wt. %, preferably 0 to 20 wt. % ., relative to the weight of the masterbatch, of (III):

(I) [R—SO₃⁻]ₙMⁿ⁺ wherein R represents an aromatic or aliphatic group, in particular also partially or completely fluorinated, M represents any metal, compounds wherein R=linear or branched aliphatic radical containing 1 to 18 carbon atoms and at least one fluorine atom, in particular perfluoroalkylated compounds containing 2 to 12 carbon atoms as well as akali and alkaline-earth metals being particularly suitable, and n corresponds to the valence of M,

(II) (Ar—SO₂—NR—)ₙM⁺ wherein Ar is an aromatic group, R a monovalent aliphatic radical or Ar and R together form a bivalent aromatic radical, M is any cation and n corresponds to the valency of M,

(III) a halogenated oligo or polycarbonate,

Further for use as a masterbatch: 0.05 to 50 wt. %, preferably 5 to 30 wt. %, relative to the weight of the masterbatch, of a polyalkylene ether compound based on propylene oxide and ethylene oxide with a propylene oxide content of ≧75 wt. %, preferably ≧80 wt. % and particularly preferably ≧90 wt. % and with a number average molecular weight of ≧2,000 g mol⁻¹, preferably ≧3,000 g mol⁻¹, in particular ≧3,500 g mol⁻¹, and 0 to 10 wt. %, preferably 0 to 3 wt. % of a fluorinated polyolefin and 0 to 20 wt. %, preferably 0 to 10 wt. % of at least one further conventional polymer additive.

Thermoplastic aromatic polycarbonates in the context of the present invention are homopolycarbonates as well as copolycarbonates; the polycarbonates may be linear or branched in a known manner.

A proportion, or up to 80 mol %, preferably 20 mol % to 50 mol % of the carbonate groups in the polycarbonates which are suitable according to the invention can be replaced by aromatic dicarboxylic acid ester groups. Polycarbonates of this type which contain acid radicals of carbonic acid as well as acid radicals of aromatic dicarboxylic acids incorporated into the molecule chain are, more precisely, aromatic polyester carbonates. For the sake of simplicity, they will be subsumed under the heading of thermoplastic aromatic polycarbonates in the present application.

The polycarbonates to be used according to the invention are produced in a known manner from diphenols, carbonic acid derivatives, optionally chain terminators and optionally branching agents, a proportion of the carbonic acid derivatives being replaced by aromatic dicarboxylic acids or dicarboxylic acid derivatives to produce the polyester carbonates, more specifically by aromatic dicarboxylic acid ester structural units depending on the carbonate structural units to be replaced in the aromatic polycarbonates.

Details concerning the production of polycarbonates have been set down in hundreds of patents over the past 40 years approximately. Reference will be made here by way of example only to

Schnell, “Chemistry and Physics of Polycarbonates”, Polymer Reviews, Volume 9, Interscience Publishers, New York, London, Sydney 1964;

D. C. Prevorsek, B. T. Debona and Y. Kesten, Corporate Research Center, Allied Chemical Corporation, Morristown, New Jersey 07960: “Synthesis of Poly(ester Carbonate) Copolymers” in Journal of Polymer Science, Polymer Chemistry Edition, Vol. 19, 75-90 (1980)”;

D. Freitag, U. Grigo, P. R. Müller, N. Nouvertne', BAYER AG, “Polycarbonates” in Encyclopedia of Polymer Science and Engineering, Volume 11, Second Edition, 1988, pages 648-718 and finally

Dres. U. Grigo, K. Kircher and P. R- Müller “Polycarbonate” in Becker/Braun, Kunststoff-Handbuch, Vol. 3/1, Polycarbonate, Polyacetale, Polyester, Celluloseester, Carl Hanser Verlag Munich, Vienna 1992, pages 117-299.

The thermoplastic polycarbonates, including the thermoplastic aromatic polyester carbonates have weight average molecular weights Mw (determined by measuring the relative viscosity at 25° C. in CH₂Cl₂ and a concentration of 0.5 g per 100 ml CH₂Cl₂) of 12,000 to 120,000, preferably of 15,000 to 80,000 and, in particular, of 16,000 to 50,000. Diphenols suitable for producing the polycarbonates to be used according to the invention include, for example, hydroquinone, resorcinol, dihydroxydiphenyl, bis-(hydroxyphenyl)-alkanes, bis-(hydroxyphenyl)-cycloalkanes, bis-(hydroxyphenyl)-sulphides, bis-(hydroxyphenyl)-ethers, bis-(hydroxyphenyl)-ketones, bis-(hydroxyphenyl)-sulphones, bis-(hydroxyphenyl)-sulphoxides, (α,α-bis(hydroxyphenyl)-diisopropyl-benzenes) and the compounds thereof alkylated in the nucleus. Preferred diphenols are 4,4′-dihydroxydiphenyl, 2,2-bis(4-hydroxyphenyl)-1-phenylpropane, 1,1-bis-(4-hydroxyphenyl)-phenyl-ethane, 2,2-bis-(4-hydroxyphenyl)-propane, 2,4-bis-(4-hydroxyphenyl)-2-methylbutane, 1,1-bis-(4-hydroxypenyl)-m/p-diisopropylbenzene, 2,2-bis-(3-methyl-4-hydroxyphenyl)-propane, bis-(3,5-dimethyl-4-hydroxyphenyl)-methane, 2,2-bis-(3,5-dimethyl-4-hydroxyphenyl)-propane, bis-(3,5-dimethyl-4-hydroxyphenyl)-sulphone, 2,4-bis-(3,5-dimethyl-4-hydroxyphenyl)-2-methylbutane, 1,1-bis-(3,5-dimethyl-4-hydroxyphenyl)-m/p-diisopropyl-benzene, 2,2- and 1,1-bis-(4-hydroxyphenyl)-3,3,5-trimethylcyclohexane.

Particularly preferred diphenols are 4,4′-dihydroxydiphenyl, 1,1-bis-(4-hydroxyphenyl)-phenyl-ethane, 2,2-bis-(4-hydroxyphenyl)-propane, 2,2-bis(3,5-dimethyl-4-hydroxyphenyl)-propane, 1,1-bis-(4-hydroxyphenyl)-cyclohexane and 1,1-bis-(4-hydroxyphenyl)-3,3,5-trimethylcyclohexane.

These and further suitable diphenols are described, for example, in U.S. Pat. Nos. 3,028,635, 2,999,835, 3,148,172, 2,991,273, 3,271,367, 4,982,014 and 2,999,846, in German Offenlegungsschriften 1 570 703, 2 063 050, 2 036 052, 2 211 956 and 3 832 396, French patent 1 561 518, in the monograph “H. Schnell, Chemistry and Physics of Polycarbonates, Interscience Publishers, New York 1964” and in Japanese Offenlegungsschriften 62039/1986, 62040/1986 and 105550/1986.

In the case of homopolycarbonates, only one diphenol is used and in the case of copolycarbonates, a plurality of diphenols are used, the bisphenols used, like all other chemicals and auxiliaries added to the synthesis possibly being contaminated with the impurities originating from their own synthesis, although it is desirable to use raw materials which are as clean as possible.

Suitable chain terminators include monophenols as well as monocarboxylic acids. Suitable monophenols include phenol, alkylphenols such as cresols, p-tert.-butylphenol, p-n-octylphenol, p-iso-octylphenol, p-n-nonylphenol and p-iso-nonylphenol.

Suitable monocarboxylic acids include benzoic acid, alkylbenzoic acids and halogen benzoic acids.

Preferred chain extenders include phenols of formula (X)

R⁶—Ph—OH (X)

wherein R⁶ represents H or a branched or unbranched C₁ to C₁₈ alkyl radical and Ph represents a bivalent aromatic radical containing 6 to 18 carbon atoms, preferably phenylene.

The quantity of chain terminator to be used is 0.5 mol % to 10 mol %, based on moles of diphenols used in each case. The chain terminators may be added before, during or after phosgenation.

Suitable branching agents are the trifunctional or higher than trifunctional compounds known in polycarbonate chemistry, in particular those with three or more phenolic OH groups.

Suitable branching agents include, for example, phloroglucine, 4,6-dimethyl-2,4,6-tri-(4-hydroxyphenyl)-heptene-2,4,6-dimethyl-2,4-6-tri-(4-hydroxyphenyl)-heptane, 1,3,5-tri-(4-hydroxyphenyl)-benzene, 1,1,1-tri-(4-hydroxyphenyl)-ethane, tri-(4-hydroxyphenyl )-phenylmethane, 2,2-bis[4,4-bis(4-hydroxyphenyl)-cyclohexyl]-propane, 2,4-bis(4-hydroxyphenyl-isopropyl)-phenol, 2,6-bis(2-hydroxy-5′-methyl-benzyl)-4-methylphenol, 2-(4-hydroxyphenyl)-2-(2,4-dihydroxyphenyl)-propane, hexa-(4-(4-hydroxyphenyl-isopropyl)phenyl)-orthoterephthalic acid ester, tetra-(4-hydroxyphenyl)-methane, tetra-(4-(4-hydroxy-phenyl-isopropyl)-phenoxy)-methane and 1,4-bis((4′,4″-dihydroxy-triphenyl)-methyl)-benzene as well as 2,4-dihydroxybenzoic acid, trimesic acid, cyanuric chloride and 3,3-bis-(3-methyl-4-hydroxyphenyl)-2-oxo-2,3-dihydroindol.

The quantity of branching agents optionally used is 0.05 mol % to 2.5 mol %, again based on moles of diphenols used in each case.

The branching agents may either be placed in the aqueous alkaline phase with the diphenols and the chain terminators or may be dissolved in an organic solvent and added prior to phosgenation.

The person skilled in the art is familiar with all these methods of producing polycarbonates.

Aromatic dicarboxylic acids suitable for producing polyester carbonates include, for example, phthalic acid, terephthalic acid, isophthalic acid, tert.-butylisophthalic acid, 3,3′-diphenyldicarboxylic acid, 4,4′-diphenyldicarboxylic acid, 4,4-benzophenonedicarboxylic acid, 3,4′-benzophenonedicarboxylic acid, 4,4′-diphenyletherdicarboxylic acid, 4,4′-diphenylsulphonedicarboxylic acid, 2,2-bis-(4-carboxyphenyl)-propane, trimethyl-3-phenylindane-4,5′-dicarboxylic acid and mixtures thereof.

Of the aromatic dicarboxylic acids, it is particularly preferable to use terephthalic acid and/or isophthalic acid and/or their derivatives. Derivatives of dicarboxylic acids include dicarboxylic acid dihalides and dicarboxylic acid dialkylesters, in particular dicarboxylic acid dichlorides and dicarboxylic acid dimethylesters and dicarboxylic acid diphenylesters.

The carbonate groups are replaced by the aromatic dicarboxylic acid ester groups in a substantially stoichiometric and also quantitative manner so the molar ratio of the reactants is repeated in the final polyester carbonate. The aromatic dicarboxylic acid ester groups may be incorporated randomly and also blockwise.

Preferred methods of producing the polycarbonates to be used according to the invention, including the polyester carbonates, include the known interfacial process and the known melt transesterification process.

Phosgene is preferably used as carbonic acid derivative in the first case and diphenyl carbonate is preferably used in the latter case. Catalysts, solvents, working up, reaction conditions, etc., for polycarbonate production are adequately described and known in both cases.

Component A

Flame-retardants which are particularly preferred according to the invention include sulphonic acid salts, sulphonic acid amide salts, halogenated benzoic acid ester salts and halogenated oligo or polycarbonates.

Sulphonic acid salts of general formula (I)

[R—SO₃⁻]ₙ⁻Mⁿ⁺ (I)

wherein

R represents an aromatic or aliphatic group, preferably a straight-chain or branched aliphatic radical containing 1 to 30 carbon atoms or an aromatic radical containing 6 to 30 carbon atoms, which may be completely or partially halogenated, in particular also partially or completely fluorinated, compounds wherein R=linear or branched aliphatic radical containing 1 to 18 carbon atoms and at least one fluorine atom, in particular perfluoroalkylated compounds containing 2 to 12 carbon atoms, n corresponds to the valence of M and

M represents any metal, akali and alkaline-earth metals being particularly suitable

They are described, for example, in U.S. Pat. No. 4,239,678—incorporated herein by reference. Completely or partially fluorinated sulphonic acid salts of general formula (I) are particularly preferred. Examples include sodium or potassium perfluorobutane sulphonate, sodium or potassium perfluoro-methane sulphonate, sodium or potassium-2,5-dichlorobenzene sulphonate, sodium or potassium-2,4,5-trichlorobenzene sulphonate, sodium or potassium diphenylsulphone sulphonate and sodium or potassium-2-formylbenzene sulphonate. According to a particularly preferred embodiment of the invention, potassium perfluorobutane sulphonate is used as flame-retardant.

Particularly suitable flame-retardants also include the sulphonic acid amide salts, described in U.S. Pat. No. 4,727,101—incorporated herein by reference, of general formula (II)

(Ar—SO₂—NR)ₙ⁻Mⁿ⁺ (II)

wherein

Ar is an aromatic radical and R is a monovalent aliphatic radical or Ar and R together form a divalent aromatic radical,

M is any cation and

n corresponds to the valency of M.

Sodium and potassium (N-benzenesulphonyl)-benzenesulphoneamide are particularly preferred sulphonic acid amide salts.

Aromatic sulphonic acid salts may also be used as flame-retardants. These are, in particular, the metal salts of monomeric or polymeric aromatic sulphonic acids described in U.S. Pat. Nos. 3,940,366 and 3,933,734—incorporated herein by reference, the sulphonic acid salts of monomeric and polymeric aromatic carboxylic acids known from U.S. Pat. No. 3,953,399—incorporated herein by reference and the esters thereof and the sulphonic acid salts of aromatic ketones described in U.S. Pat. Nos. 3,926,908 and 4,104,246—incorporated herein by reference.

Preferred examples are: Sodium- or Potassium-2,5-dichlorobenzenesulphate, Sodium- or Potassium-2,4,5-trichlorobenzenesulphate, Sodium- or Potassiumpentachlorobenzoate, Sodium- or Potassium-2,4,6-trichlorobenzoate, Sodium- or Potassium-2,4-dichlorobenzoate, Sodium- or Potassium-diphenylsulphone-sulphonate, Sodium- or Potassium-2-formylbenzenesulphonate, Sodium- or Potassium-(N-benzenesulphonyl)-benzenesulphonamide.

Suitable halogenated oligo- or polycarbonates include fluorinated, chlorinated and/or brominated oligo- or polycarbonates, the oligo- or polycarbonates containing at least one fluorinated, chlorinated and/or brominated diol unit and having a weight average molecular weight Mw of 500 to 100,000, preferably 1,000 to 40,000 and particularly preferably 1,000 to 8,000.

Oligo- or polycarbonates which contain between 0.1 and 100 wt. %, preferably between 1 and 100 wt. %, particularly preferably between 10 and 100 wt. %, preferably 100 wt. % of fluorinated, chlorinated and/or brominated 2,2-bis-(4-hydroxyphenyl)-propane as diol unit are particularly preferred. 2,2-bis-(3,5-dibromo-4-hydroxyphenyl)-propane (tetrabromobisphenol) is particularly preferably suitable as diol. A poly- or oligocarbonate of 2,2-bis-(3,5-dibromo-4-hydroxyphenyl)-propane is preferably used.

As branching agents or chain terminators the same copmounds ar suitable as they are with regard to the polcarbonate matrix.

Component B

As antistatic agent, the compositions according to the invention contain at least one polyalkylene ether compound of general formula (V)

R₁—O—(CₓH₂ₓO)ₙ—R₂ (V).

In formula (V)

R₁ and R₂, independently of one another, represent hydrogen, a saturated or unsaturated hydrocarbon radical or an acyl radical,

x represents the numbers 2 or 3, wherein the value of x may vary between 2 and 3 within in the same molecule in a way that the proportion of monomers wherein x=3 is at least 75 wt. %, preferably at least 80 wt. % and particularly preferably at least 90 wt. %, and

n is a number which is selected in such a way that the number average molecular weight of the polyalkylene ether (determined by measuring the hydroxyl value)≧2,000 g mol⁻¹, preferably ≧3,000 g mol⁻¹, in particular ≧3,500 g mol⁻¹.

Polyalkylene ethers of formula (V) which simultaneously contain monomer units wherein x=2 and x=3, in other words both ethylene and propylene oxide units, may be both randomly distributed in the polyalkylene ether chain and arranged in blocks of pure polyethylene oxide, pure propylene oxide and/or randomly mixed polyethylene propylene oxide. Linear three-block copolymers made up of homopolymer blocks are preferred.

Preferred polyalkylene ethers include pure polypropylene oxides and three-block copolymers of general formula X-Y-X with a central polypropylene oxide block Y and terminal polyethylene oxide blocks X. The combined proportion of the two terminal polyethylene blocks X in the three-block copolymer may be 0 to 40, preferably 0 to 30, in particular 0 to 20 wt. %. The proportion of the central polypropylene oxide block Y is accordingly 60 to 100, preferably 70 to 100, in particularly 80 to 100 wt. %. The three-block copolymers are produced by polymerisation in a manner known per se, a central polypropylene oxide block Y initially being produced and having a block of ethylene oxide units added to each of its two ends (cf., for example, N. Schönfeld, Grenzflächenaktive Ethylenoxid-Addukte, Wissenschaftliche Verlagsgesellschaft mbH, Stuttgart, 1967, pages 53 ff.). Preferred three-block copolymers and the production thereof are also described in EP-A-0 135 801 and EP-A-0 018 591.

The polyalkylene ethers used as component (B) may also be reacted with radical forming agents by the methods described in EP-A2-0 278 348 and U.S. Pat. No. 4,920,166—incorporated herein by reference, to increase their antistatic activity. Conventional compounds known as initiators for radical polymerisation as well as any other compounds which decompose sufficiently fast at temperatures between 20 and 200° C. to form radicals may be used as radical-forming substances. Thus, for example, diacyl peroxides such as dibenzoyl peroxide, substituted dibenzoyl peroxides and dilauroyl peroxide, acylsulphonyl peroxides such as acetylcyclohexane-sulphonyl peroxide, peroxydicarbonates such as dicyclohexyl and di-tert.-butylperoxydicarbonate, acylperesters such as tert.-butylperpivalate and tert.-butylperbenzoate, dialkyl peroxides such as dicumyl and di-tert.-butylperoxide, hydroperoxides such as cumylhydroperoxide and tert.-butylhydroperoxide and other peroxy compounds as well as aliphatic and araliphatic azo compounds may be used. Preferred radical forming agents decompose sufficiently fast at temperatures of 60 to 140° C., for example azodiisobutylronitrile, di-tert.-butylperoxide, dibenzoylperoxide, tert.-butylperbenzoate, dicumylperoxide and 1,3-bis-(tert.-butylperoxy-isopropyl)benzene. Dibenzoylperoxide is particularly preferably used.

The polyalkylene ethers according to the invention, modified by reaction with radical forming agents may be produced by merely stirring the radical forming agent with the respective polyalkylene ether at temperatures between 50 and 150° C. The quantity of radical forming agent used in the process is 0.05 to 5 wt. %, preferably 0.1 to 2.0 wt. % and particularly preferably 0.25 to 1.0 wt. %, based on the quantity of polyalkylene ether.

Owing to its lower plasticizer activity and their lower volatility, but not their higher efficiency as antistatic agents, these polyalkylene ethers are preferably used with a number average molecular weight of ≧2,000 g mol⁻¹, preferably of ≧3,000 g mol⁻¹, in particular of ≧3,500 g mol⁻¹.

Component C

As component C, the compositions according to the invention may also contain fluorinated polyolefins and anti-drip agents.

The fluorinated polyolefins may also be used in the form of a masterbatch produced by emulsion polymerisation of at least one monoethylinically unsaturated monomer in the presence of an aqueous dispersion of the fluorinated polyolefin. Styrene, acrylonitrile and mixtures thereof are preferred monomer components. After acidic precipitation and subsequent drying, the polymer may be used as a free-flowing powder.

The coagulates, precompounds and masterbatches usually have solids contents of fluorinated polyolefin of 5 to 95 wt. %, preferably 7 to 60 wt. %.

With specific flame-retardant requirements, the compositions may additionally contain fluorinated hydrocarbons, in particular fluorinated polyolefins. The fluorinated polyolefins which may be used have high molecular weights and glass transition temperatures in excess of −30° C., generally in excess of 100° C. The fluorine contents of the fluorinated polyolefins are preferably 65 to 76 wt. %, in particular 70 to 76 wt. %. The median particle diameter d₅₀ of the fluorinated polyolefins is 0.05 to 1,000 μm, preferably 0.08 to 20 μm. The fluorinated polyolefins generally have a density of 1.2 to 2.3 g/cm³. Preferred fluorinated polyolefins include polytetrafluoroethylene, polyvinylidenefluoride, tetrafluoroethylene/hexafluoropropylene and ethylene/tetrafluoroethylene copolymers. Fluorinated polyolefins of this type are described, for example, in Schildknecht “Vinyl- and Related Polymer”, John Wiley & Sons, Inc. New York, 1962, p.484-494; Wall “Fluoropolymers”, Wiley-Interscience, John Wiley & Sons, Inc. New York, Vol. 13, 1970, p. 623-654; “Modern Plastics Encyclopedia”, 1970-1971, Vol. 47, No. 10 A, October 1970, Mc Graw-Hill, Inc., New York, p.134 and 774; “Modern Plastics Encyclopedia”, 1975-1976, October 1975, Vol. 52, No. 10 A, McGraw-Hill, Inc., New York, p. 27, 28 and 472 as well as in U.S. Pat. Nos. 3,671,487, 3,723,373 and 3,838,092 all incorporated herein by reference.

The quantity of fluorinated hydrocarbons to be used in the thermoplastic molding composition depends on the desired properties of the material and can be varied in wide limits. The quantity of fluorinated polyolefins is preferably 0.001 to 0.5 wt. %, in particular 0.01 to 0.1 wt. %, based on the total weight of the molding composition.

According to a particularly advantageous embodiment of the invention, polytetrafluoroethylene is used as fluorinated hydrocarbon. Particularly good flame-retardant behaviour is achieved in the composition without impairing the other material properties if polytetrafluoroethylene is used in a quantity of 0.001 to 0.5 wt. %, in particular 0.01 to 0.1 wt. %, based on the total weight of the molding composition.

Component D

For achieving improved plastic molding compounds, it is also possible additionally to incorporate at least one further additive usually present in thermoplastic polymers, preferably poly- and copolycarbonates such as stabilizers (as described, for example, in EP Al 0 839 623 or EP A1 0 500 496), in particular heat stabilizers, more particularly organic hindered phenols, hindered amines (HALS), phosphites or phosphines, for example and preferably triphenol phosphine, further known mold release agents, for example and preferably fatty acid esters of glycerine or tetramethanol methane is additionally incorporated, wherein unsaturated fatty acid may also be completely or partially epoxidised, in particular glycerine monostearate (GMS) or pentaerythritoltetrastearate (PETS), UV absorbers, for example and preferably hydroxybenzotriazoles, hydroxybenzophenones and hydroxytriazines, fillers, glass fibers, foaming agents, dyes, pigments, optical brighteners, ester interchange catalysts and nucleation agents.

Suitable glass fibers include any commercially available sorts and types of glass fiber, in other words types of cut glass, chopped strands and milled fibers, providing they are made compatible with polycarbonate by means of suitable sizes. The glass fibers used to produce the molding compounds are produced from low-alkali glass. According to DIN 1259, low-alkali glass is an aluminium boron silicate glass with an alkali oxide content of less than 1 wt. %. Glass fibers with a diameter of 8 to 20 μm and a length of 3 to 6 mm (chopped strands) are usually used. Milled fibers as well as suitable glass beads may also be used.

However, the above-mentioned definitions and explanations provided in general or in preferred ranges may also be combined with one another as desired, in other words between the respective ranges and preferred ranges. They apply to the final products and to the precursors and intermediate products.

The molding compositions according to the invention contain components A and B, optionally C and/or D and optionally further additives. They are produced by mixing the respective components in a known manner and compounding or extruding the melt at temperatures of 250° C. to 380° C. in conventional units such as internal kneaders, extruders, including twin screw extruders.

The individual components may be mixed both in succession and simultaneously in a known manner, more specifically at both 20° C. (ambient temperature) and at elevated temperature.

Owing to their excellent flame-retardant properties and their good mechanical and thermal properties and owing to their good processing behaviour, the thermoplastic compositions according to the invention are suitable for the production of molded articles of any type. The molded articles may be transparent, translucent or opaque. In principle, the molded articles may be produced by any known methods, for example by injection molding and extrusion. The molding compounds are preferably suitable for the production of molded articles by injection molding.

Possible applications of the plastics compositions according to the invention include:

1. Safety glass which is required, as known, in many areas of buildings, vehicles and aircraft, and as visors for helmets,

2. Production of extruded and solution films for displays or electric motors and also ski foils,

3. Production of blow-molded parts (see, for example, U.S. Pat. No. 2,964,794),

4. Production of translucent sheets, in particular twin-wall sheets, for example for covering buildings such as railway stations, greenhouses and lighting installations,

5. For producing traffic light housings or traffic signs,

6. For producing foams (see. for example, DE-A 1 031 507),

7. For producing threads and wires (see, for example, DE-A 1 137 167 and DE-A 1 785 137),

8. As translucent plastics materials with a glass fiber content for lighting technology (see, for example, DE-A 1 554 020),

9. For producing precision injection molding particles such as lens mounts. Fiber glass-containing polycarbonates which optionally also contain about 1 to 10 wt. % MoS2, based on the total weight, are used for this purpose,

10. Optical applications such as optical memories (CDs, DVDs) and their housings, safety goggles or lenses for photographic and film cameras (see, for example, DE-A 2 701 173),

11. As light transmitting media, in particular as optical cables (see, for example, EP-A 0 089 801),

12. As electrical insulators for electrical conductors and for plug housings as well as plug connectors,

13. As supporting material for organic photoconductors,

14. For producing lamps, for example spotlights, as so-called headlamps or diffusing screens or lamp covers,

15. For medical applications, for example oxygenisers, dialysers,

16. For domestic articles such as kitchen sinks and letter boxes,

17. For casings such as electrical distribution cabinets, electrical appliances, household appliances,

18. Components of household articles, electrical and electronic devices,

19. For producing motor cycle and safety helmets,

20. Car parts such as windows, dashboards, body parts and shock absorbers.

It is preferable to use the plastic compositions according to the invention for

1. Safety glass, and as visors of helmets,

2. Production of translucent sheets, in particular twin-wall sheets, for example for covering buildings such as railway stations, greenhouses and lighting installations,

3. Optical applications such as optical memories (CDs, DVDs) and their housings, safety goggles or lenses for photographic and film cameras (see, for example, DE-A 2 701 173),

4. For casings such as electrical distribution cabinets, electrical appliances, household appliances,

5. For producing lamps, for example spotlights, as so-called headlamps or diffusing screens or lamp covers,

6. For producing motor cycle and safety helmets.

The plastics compositions according to the invention may also be used to produce multi-layer systems. The plastics composition according to the invention is applied in a thin layer to a molded article made of a plastics material which does not have antistatic properties. It may be applied simultaneously with or directly after shaping of the molded article, for example by coextrusion or multi-component injection molding. However, it may also be applied to the ready molded basic body, for example by lamination with a film or by coating with a solution.

The invention also relates to the method of producing the molding compounds according to the invention, to their use for producing molded articles of any type and to these molded articles themselves.

The invention is further illustrated but is not intended to be limited by the following examples in which all parts and percentages are by weight unless otherwise specified.

### EXAMPLES

PC1

Polycarbonate based on bisphenol A with a relative solution viscosity of 1.28 measured in methylenechloride at 25° C. and in a concentration of 0.5 g/100 mol from Bayer AG, Leverkusen, Germany under the trademark Makrolon® 2808.

PC2

Polycarbonate based on bisphenol A with a relative solution viscosity of 1.24 measured in methylenechloride at 25° C. and in a concentration of 0.5 g/100 mol from Bayer AG, Leverkusen, Germany under the trademark Makrolon® 2408.

Component A.1

Potassium perfluorobutanesulphonate from Bayer AG, Leverkusen, Germany.

Component A.2

Potassium diphenylsulphonate (commercially available, for example, from Seal Sands Chemicals Ltd, a Cambrex Company, Middlesborough, TS2 1UB, United Kingdom or easy to produce in accordance with U.S. Pat. No. 3,948,851).

Component A.3

Tetrabromobisphenololigocarbonate (Great Lakes Chemical Corp., Lafeyette, Ind., USA).

Component B.1 (AT36)

Modified linear polypropylene glycol: 1.0 kg of a linear polypropylene glycol with a number average molecular weight of about 2,000 g mol⁻¹ (hydroxyl value=56) is degassed under vacuum at 120° C. and subsequently saturated with nitrogen. After addition of 6.6 g dibenzoylperoxide at a temperature <40° C., the resultant mixture is reacted under nitrogen for 8 hours at 80 to 85° C.

Component B.2 (5168)

Three-block copolymer with the structure X-Y-X with a central polypropylene oxide block Y and terminal polyethylene oxide blocks X. The propylene oxide content of the block copolymer is 86.7 wt. %; the number average molecular weight is about 4,000 g mol⁻¹ (hydroxyl value=27).

Component C.1

Polytetrafluoroethylene (Teflon 6CN, Du Pont de Nemours, Wilmington, Del., USA).

Component D.1

PETS (pentaerythritoltetrastearate from Henkel AG, Dusseldorf, Germany).

Component D.2

Titanium dioxide (Cronos Titanium C12230).

Compounds O.1 and O.2 were used to produce comparison samples as examples of the state of the art:

Component O.1

Armostat 3002 (sodium alkane sulphonate, Akzo Nobel Chemicals GmbH, Düren, Germany).

Component O.2

Statexan K1 (sodium alkane sulphonate, Bayer AG, Leverkusen, Germany).

Production and Examination of the Molding Compounds According to the Invention

To produce the specimens, polycarbonate is compounded at 280 to 295° C. on a twin-shaft extruder with the quantity of additives specified in Table 1, and is then granulated.

Rectangular plates are then injection molded from these granules at 300 or 320° C. melt temperatures (155 mm×75 mm×2 mm).

The sheets are subjected to the dust test after two or more hours' storage. The results are given in Table 1.

Dust Test

In order to investigate the settlement of dust in a laboratory test, the injection molded sheets are exposed to an atmosphere containing swirled dust. For this purpose, a 2 l beaker with an 80 mm long magnetic stirring rod having a triangular cross-section is filled with dust (coal dust/20 g activated charcoal, Riedel-de Haen, Seelze, Germany, Article No. 18003) to a depth of about 1 cm. The dust is swirled using a magnetic stirrer. After stopping the stirrer, the specimen is exposed to this dust-laden atmosphere for 7 sec. More or less dust settles on the specimens, depending on the specimen used.

The settlement of dust (dust patterns) is evaluated visually. Sheets having dust patterns were evaluated negatively (−), sheets virtually free of dust patterns were evaluated with (+).

The flame-retardant properties are assessed in accordance with UL94V (Test for Flammability of Plastic Materials for Parts in Devices and Appliances, Underwriters Laboratories, Northbrook, Ill., USA) on rods with a thickness of 1.6 mm or 3.2 mm.

TABLE 1

| | | | | | | | PPG/ | | | | Armo- | Statexan | | | | |
|---|---|---|---|---|---|---|---|---|---|---|---|---|---|---|---|---|
| | M2808 | M2408 | C4-Salt | DPS | TBBOC | PPG | PEG | PTFE | PETS | TiO₂ | stat3002 | K1 | Dust | | Thickness | Trans- |
| Nr. | PC1 | PC2 | A1 | A2 | A3 | B1 | B2 | C1 | D1 | D2 | O1 | 02 | pattern | ULV0 | [mm] | parency |
| V1 | 0 | 97.6 | 0 | 0.35 | 1 | 0 | 0 | 0.09 | 0 | 1 | 0 | 0 | − | V0 | 1.6 | w |
| V2 | 0 | 98.4 | 0.2 | 0 | 0 | 0 | 0 | 0.09 | 0.3 | 1 | 0 | 0 | − | V0 | 1.6 | w |
| V3 | 0 | 96.4 | 0.2 | 0 | 0 | 0 | 0 | 0.09 | 0.3 | 1 | 2 | 0 | + | n.b. | 1.6 | w |
| V4 | 0 | 95.4 | 0.2 | 0 | 0 | 0 | 0 | 0.09 | 0.3 | 1 | 0 | 3 | + | n.b. | 1.6 | w |
| V5 | 0 | 97.7 | 0 | 0 | 0 | 0 | 1 | 0 | 0.3 | 1 | 0 | 0 | − | V2 | 1.6 | w |
| V6 | 0 | 96.7 | 0 | 0 | 0 | 0 | 2 | 0 | 0.3 | 1 | 0 | 0 | − | V2 | 1.6 | w |
| V7 | 0 | 97.7 | 0 | 0 | 0 | 1 | 0 | 0 | 0.3 | 1 | 0 | 0 | − | V2 | 1.6 | w |
| V8 | 0 | 96.7 | 0 | 0 | 0 | 2 | 0 | 0 | 0.3 | 1 | 0 | 0 | − | V2 | 1.6 | w |
| 1 | 0 | 97.4 | 0.2 | 0 | 0 | 1 | 0 | 0.09 | 0.3 | 1 | 0 | 0 | + | V0 | 1.6 | w |
| 2 | 0 | 96.4 | 0.2 | 00 | 0 | 2 | 0 | 0.09 | 0.3 | 1 | 0 | 0 | + | V0 | 1.6 | w |
| 3 | 0 | 95.6 | 0 | 0.35 | 1 | 2 | 0 | 0.09 | 0 | 1 | 0 | 0 | + | V0 | 1.6 | w |
| 4 | 0 | 91.9 | 0 | 0 | 5 | 2 | 0 | 0.09 | 0 | 1 | 0 | 0 | + | V2 | 1.6 | w |
| 5 | 80 | 17.7 | 0.06 | 0 | 0 | 2 | 0 | 0 | 0.3 | 0 | 0 | 0 | + | V2 | 3.2 | t |
| 6 | 80 | 17.7 | 0.08 | 0 | 0 | 2 | 0 | 0 | 0.3 | 0 | 0 | 0 | + | V2 | 3.2 | t |
| 7 | 90 | 6.9 | 0 | 0.35 | 0.5 | 2 | 0 | 0 | 0.3 | 0 | 0 | 0 | + | V0 | 3.2 | t |
| 8 | 0 | 97.4 | 0.2 | 0 | 0 | 0 | 1 | 0.09 | 0.3 | 1 | 0 | 0 | + | V0 | 1.6 | w |
| 9 | 0 | 96.4 | 0.2 | 0 | 0 | 0 | 2 | 0.09 | 0.3 | 1 | 0 | 0 | + | V0 | 1.6 | w |
| 10 | 0 | 95.4 | 0.2 | 0 | 0 | 0 | 3 | 0.09 | 0.3 | 1 | 0 | 0 | + | V0 | 1.6 | w |

Compositions of the individual samples:
t = transparent
w = white
o = opaque or translucent
n.b. = not successful in UL test
Thickness = thickness of the sample for the UL test

Comparison examples V3 and V4 show that although freedom from dust is achieved with conventional antistatic agents (Armostat 3002 or Statexan), the UL test is failed despite the addition of flame retardants.

Comparison examples V1 to V2 show that flame-proofed PC only forms dust patterns.

Comparison examples V5 to V8 show that dust patterns cannot be prevented by addition of the polyalkylene ether compound according to the invention without flame-retardant.

On the other hand, it is possible with the polyalkylene ether compound according to the invention in combination with the flame-retardants according to the invention in examples 1 to 10 according to the invention to obtain both transparent and opaque formulations which are successful in UL V0 and V2 tests, without dust patterns.

A synergistic effect between the polyalkylene ether compound according to the invention and the flame-retardants according to the invention could therefore be found, which meets the list of requirements defined at the outset.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A thermoplastic molding composition comprising
(a) an aromatic (co) polycarbonate
(b) 0.001 to 5 wt % relative to the weight of the composition of at least one flame retardant selected from the group consisting of
(I) [R—SO₃⁻]ₙMⁿ⁺
wherein
R represents an aromatic or aliphatic group,
M represents a cation, and
n corresponds to the valence of M,
(II) (Ar—SO₂—NR—)ₙM⁺
wherein
Ar is an aromatic group, R a monovalent aliphatic radical or Ar and R together form a bivalent aromatic radical,
M is a cation and
n corresponds to the valence of M,
and/or 0 to 6 wt % relative to the weight of the composition of
(III) a halogenated oligo- or polycarbonate containing at least one fluorinated, chlorinated and/or brominated diol unit and having a weight average molecular weight Mw of 500 to 100,000,
and
(c) a polyalkylene ether compound conforming to the formula
R₁—O—(CₓH₂ₓO)ₙ—R₂
wherein
R₁ and R₂, independently represent hydrogen, a saturated or unsaturated hydrocarbon radical or an acyl radical, and
x represents 2 or 3, and
n corresponds to the polyalkylene ether compound having a number average molecular weight of at least 2,000 g mol⁻¹, and wherein the content of propylene oxide is at least 75% relative to the weight of the polyalkylene ether compound.

2. The composition of claim 1 wherein flame retardant is (I) and where R denotes a linear or branched aliphatic radical containing 1 to 18 carbon atoms and at least one fluorine atom.

3. The composition of claim 2 wherein flame retardant is (I) and R is perfluoroalkylated compound containing 2 to 12 carbon atoms.

4. The composition of claim 2 wherein flame retardant is (I) and said M is alkali metal or alkaline-earth metal.

5. A molded article comprising the composition of claim 1.

6. The composition of claim 1 further containing a fluorinated polyolefin.

7. The composition of claim 1 further containing at least one member selected from the group consisting of stabilizers, mold release agents, antistatic agents, UV absorbers, fillers, glass fibers, foaming agents, dyes, pigments, optical brighteners, ester interchange catalysts and nucleation agents.
